(19) United States
(12) Patent Application Publication
(10) Pub. No.: US 2007/0139934 A1
(43) Pub. Date: Jun. 21, 2007

(54) Decorative lamp holder with two lighting spots

(76) Inventor: Fong-shi Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/304,556

(22) Filed: Dec. 16, 2005

(51) Int. Cl. F21V 15/00

(52) U.S. Cl. 362/362

(57) ABSTRACT

The invention relates to a decorative lamp holder with two lighting spots, wherein the holder can be transparent by light and can be designed with various configurations as desired. A bulb assembly is connected with the lamp holder, which includes a bulb having two light spots. One of the lighting spots is exposed to the air and the other is hidden in the lamp holder. A direct light of the bulb and a soft light from the holder are composite to become a special lighting decorative effect to obtain a predicted utilization.

### BACKGROUND OF THE INVENTION

In present time, lighting bulbs, such as in a light string, are usually used for decoration popularly. In order to provide different effects, there is a design, which is to connect the bulb with a special patterned decoration for a various outlook. There is also another design to receive the bulb totally in a transparent decoration. By use of this semi-transparent light from the bulb through the skin-surface of the decoration, it shows a soft lighting to increase the decorative effect. Both of the prior art are only simply connected with the patterned object and the structure of them are without specific and innovation.

The present invention is to provide a new model of a decorative lamp holder with two lighting spots, one of which is hidden in the holder while the other is exposed to the air that provides a special lighting composite to increase the decorative effect. Now, accompanying with the following drawings, the character of the present invention will be described here and after.

### BRIEF DESCRIPTION OF THE DRAWINGS

FIG. 1 is a perspective view showing a decorative lamp holder with two lighting spots according to the present invention.

FIG. 2 is a cross-sectional plan view of FIG. 1.

FIG. 3 is a cross-sectional plan view showing a modified decorative lamp holder according to the present invention.

### DETAILED DESCRIPTION OF THE PREFERRED EMBODIMENT

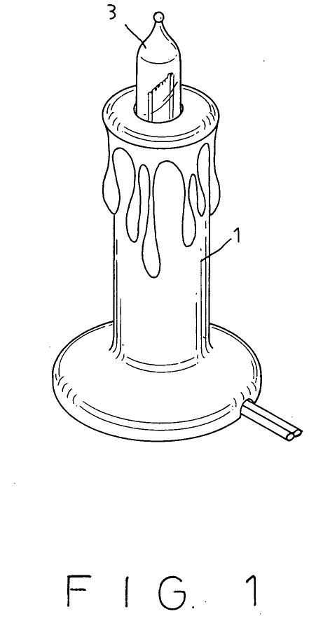

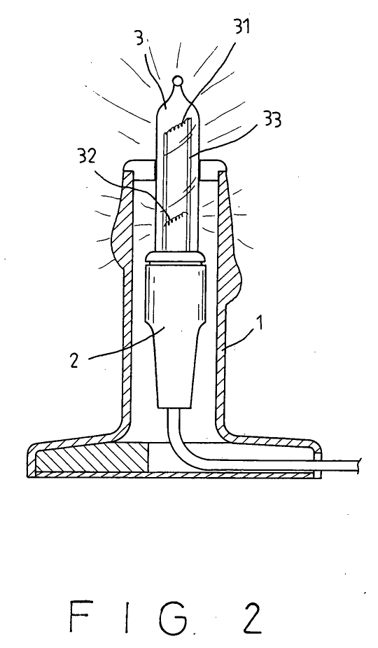

Referring to FIG. 1 and 2, the present invention includes a patterned lamp holder (1), which can be designed with other configurations and is transparent for light, and a bulb assembly (2) received therein. The character of the present invention is to provide the bulb assembly (1) including a bulb (3) with two lighting spots. For example in this application, the bulb (3) includes two conductive wires (33) to connect with two parallel tungsten filaments (31) and (32). The upper filament (31) is exposed outside the holder (1) and the lower filament (32) is hidden in the lamp holder (1).

In use, when the bulb (3) is turned on, two tungsten filaments (31) and (32) are lightened at the same time. At this time, the upper filament (3 1) emits light out directly while the lower filament (32) emits light to pass through the body of the transparent lamp holder (1) to become a soft lighting. Hence, the direct lighting from the upper filament (31) and the soft lighting from the lower filament passing through the holder (1) are composite to show a double lighting spots on a single decoration that obtains a unique decorative effect.

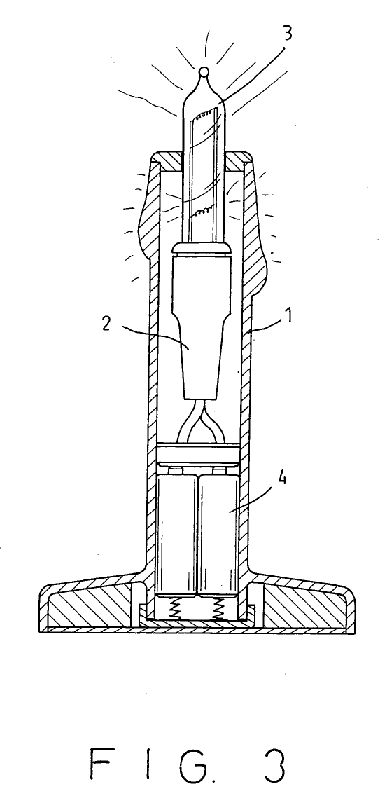

Accordingly, the present invention applies a single bulb to produce two lighting sources, one of which is exposed and the other one is hidden in the decoration that obtains a special lighting effect and is better than any prior art. It is also to be understood that the above-mentioned embodiments are only exemplary of the present invention. Any modification with the same or similar merit is still claimed in this application, such as shown in FIG. 3, a battery (4) is provided in the lamp holder (1) to supply electrical power for bulb (3) instead of an AC power.

I claim:

1. A decorative lamp holder with two lighting spots including a patterned lamp holder being transparent by light and a bulb assembly having a bulb with two lighting spots, one of which is exposed to the air and the other is received totally in the holder.

2. The decorative lamp holder with two lighting spots as claimed in claim 1, wherein the bulb has two conductive wires and two tungsten filaments.

3. The decorative lamp holder with two lighting spots as claimed in claim 1, wherein a battery is provided in the lamp holder to provide electrical power for bulb assembly.
